(19) United States
(12) Patent Application Publication
(10) Pub. No.: US 2018/0126803 A1
(43) Pub. Date: May 10, 2018

(54) PNEUMATIC VEHICLE TIRE

(71) Applicant: Continental Reifen Deutschland GmbH, Hannover (DE)

(72) Inventors: Matthias Jacob, Leipzig (DE); Oliver Schuermann, Langenhagen (DE)

(21) Appl. No.: 15/861,436

(22) Filed: Jan. 3, 2018

Related U.S. Application Data
(63) Continuation of application No. PCT/EP2016/054263, filed on Mar. 1, 2016.

(30) Foreign Application Priority Data
Jul. 3, 2015 (DE) 102015212489.4

(51) Int. Cl. B60C 19/00; B29C 73/16; B60C 5/00

(52) U.S. Cl. CPC B60C 19/002; B29D 2030/0686; B60C 5/002; B29C 73/163

(57) ABSTRACT

The invention is directed to a pneumatic vehicle tire which includes a foam sound absorber in its interior, adhesively attached to the inner surface opposite from the tread and extending in an annular manner over the circumference of the tire. The sound absorber adheres to a previously applied, self-sealing sealant which, at least immediately after its application, has a tackiness required for the adhesive attachment of the sound absorber. The sound absorber is made up of a plurality of annular component sound-absorber elements that extend in the circumferential direction. Two directly adjacently arranged annular component sound-absorber elements are spaced apart from one another in the axial direction by a clear distance.

### CROSS REFERENCE TO RELATED APPLICATIONS

This application is a continuation application of international patent application PCT/EP2016/054263, filed Mar. 1, 2016, designating the United States and claiming priority from German application 10 2015 212 489.4, filed Jul. 3, 2015, and the entire content of both applications is incorporated herein by reference.

### FIELD OF THE INVENTION

The invention relates to a pneumatic vehicle tire including a foam sound absorber in its interior, adhesively attached to the inner surface opposite from the tread and extending in an annular manner over the circumference of the tire. The sound absorber adheres to a previously applied, self-sealing sealant, which at least immediately after its application has a tackiness required for the adhesive attachment of the sound absorber.

### BACKGROUND OF THE INVENTION

Such a pneumatic vehicle tire is known from EP 2006125 A1. The inner absorber is a one-piece ring of open-cell foam which reduces the vibration of air in the tire and leads to an improvement in the noise conditions in the vehicle. The high-viscosity sealant applied to the inner side of the tire has two functions: it seals an undesired puncture of the tire in the region of the tread, in that in the event of damage to the inner layer the viscous sealant flows into the location of the damage. Moreover, the sealant serves at the same time as a “bonding agent” for securing the sound-absorbing foam ring.

However, the flow characteristics of the high-viscosity sealant may be adversely affected by the inner absorber lying on the sealant over its full surface area, meaning that the desired sealing effect only occurs after a delay or not at all. In cases wherein the penetrating foreign body comes out of the tire again and leaves a large air channel, reliable sealing by the sealant adversely affected in terms of its flow characteristics is particularly difficult.

“Highly viscous” should be understood here as meaning a sealant of which the viscosity is more than 10 Pa·s.

### SUMMARY OF THE INVENTION

It is an object of the invention to improve the sealing of the tire in the event of punctures while improving the sound absorption.

The stated object is achieved according to the invention by the sound absorber including a plurality of annular component sound-absorber elements that extend in the circumferential direction and are arranged adjacent to one another in the axial direction. Two directly adjacently arranged annular component sound-absorber elements are arranged spaced apart from one another in the axial direction by a clear distance.

According to the invention, the sound absorber is not a one-piece annular sound absorber extending over the circumference of the tire, but instead the sound absorber includes a plurality of annular component sound absorbers extending in the circumferential direction. These component sound absorbers are arranged parallel and spaced apart from one another, that is, without contact. Each component sound-absorber element preferably extends over at least 340° of the circumference of the tire, that is, the annular component sound-absorber element may be a closed ring element or a non-closed ring element that has a gap between its two ends.

The sound absorption is improved as a result of the increased surface provided by the plurality of component sound-absorber elements in comparison with a single sound-absorbing ring. As a result of being spaced apart from one another, the plurality of annular component sound-absorber elements cover only part of the surface of the sealant. The sealant has free surfaces that are not covered by component sound absorbers, whereby the flow characteristics of the sealant in the event of punctures, and consequently the sealing of the tire, are improved.

There are arranged as many component sound absorbers of a suitable size that the volume of the sound absorber consisting of the component sound absorbers takes up between 1 and 30%, preferably between 10 and 15%, with respect to the volume of the cavity that is formed by the interior space of the operationally ready tire mounted on the rim.

It is advantageous if the clear distance between two directly adjacently arranged component sound-absorber elements is 5 mm to 15 mm, preferably 8 mm to 12 mm, particularly preferably approximately 10 mm, measured in the axial direction at the level of the widest extent of the component sound-absorber elements. This distance between the component sound-absorber elements allows reliable flow characteristics of the sealant in the event of tread punctures.

It is practical if the cross section of the component sound-absorber element has the form of a circle, a semicircle or a regular or irregular polygon, such as preferably a regular triangle or a regular quadrangle. In this case, either a narrow side or a broad side of the component sound absorber may lie on the sealant. If the narrow side lies on the sealant, the flow characteristics of the sealant are improved further. If the broad side lies on the sealant, the component sound-absorber element is arranged securely on the sealant in terms of tipping over.

It is practical if the width of the component sound-absorber element is 5 mm to 200 mm, preferably 5 mm to 100 mm, especially preferably 10 mm to 20 mm, measured in the axial direction at the elevation of the widest extent of the component sound-absorber element. Especially in conjunction with the spacing apart of the component sound-absorber elements, best possible flow characteristics of the sealant along with best possible sound absorption are achieved.

All sealants that are self-sealing and, at least immediately after application to the inner surface of the tire, are tacky enough that the subsequently applied sound absorber can be adhesively bonded with the sealant come into consideration within the scope of the invention. Therefore, sealants based on polyurethane or sealants that are a viscous mixture based on a butyl rubber, a polybutene or based on silicone are suitable, for example.

It is advantageous if the layer thickness of the sealant is between 2 mm and 5 mm, preferably approximately 3.5 mm. While providing reliable sealing in the event of punctures, the improved flow characteristics of the sealant make it possible to reduce the layer thickness of the sealant by 30%-50% in comparison with the layer thickness of the sealant with the foam ring lying over the full surface area. This advantageously saves costs and also tire weight.

### BRIEF DESCRIPTION OF THE DRAWINGS

The invention will now be described with reference to the drawings wherein:

FIG. 1 shows a cross section through a pneumatic vehicle tire of the prior art; and,

FIG. 2 shows a cross section through a pneumatic vehicle tire according to the invention.

### DESCRIPTION OF THE PREFERRED EMBODIMENTS OF THE INVENTION

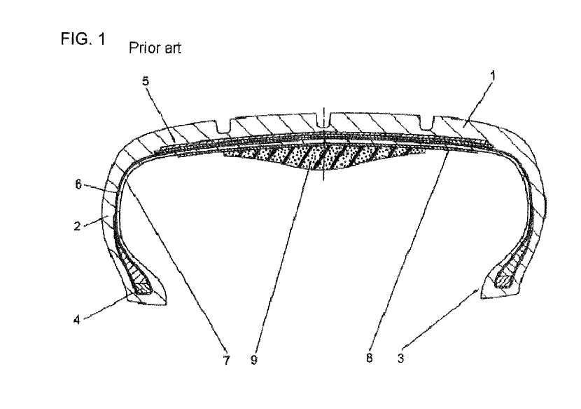

FIG. 1 is a cross section through a radial automobile tire having a profiled tread 1, sidewalls 2, bead regions 3, bead cores 4 and also a multi-ply belt assembly 5 and a carcass insert 6. On its inner surface, the tire is covered with an inner layer 7 of an airtight rubber compound. Applied to the inner surface of the inner layer 7, the inner surface being opposite from the tread 1, is a sealant 8 which, in the event of a puncture (tire damage), is capable of acting in a self-sealing manner. Adhering to the sealant 8 over the full surface area is a one-piece annular inner absorber 9 assuming the function of a sound absorber, which, immediately after the application of the sealant 8, is pressed onto the sealant 8 while the latter is still sufficiently tacky. With respect to its sound-absorbing properties, the inner absorber 9 is configured appropriately for the tire cavity frequency. The inner absorber 9 has here for example an approximately elongated triangular cross section that is symmetrical with respect to the radially extending axis of symmetry of the tire and adheres by its bottom side on the sealant 8 over the full surface area. The foam of the inner absorber 9 is an open-cell foam, since this is best suited for absorbing sound. Possible sealants are, for example, polyurethane gels or viscous mixtures based on butyl rubbers, polybutenes or silicone, it being possible for the mixtures to contain the customary further constituents, such as plasticizer oils. The sealant is introduced, for example by spraying, such that it covers at least the inner surface opposite from the tread 1. The tire can be rotated in order to optimally distribute the sealant on the inner surface. Furthermore, the sealant is introduced in such an amount that the layer thickness of the sealant is between 7 mm and 8 mm. At least immediately after application, the sealant should be relatively liquid and tacky. At this time, the prefabricated one-piece inner absorber 9 is introduced into the interior of the tire. After full reaction, the inner absorber 9 adheres to the sealant 8, which is elastically deformable, but remains immobile or stationary to the greatest extent.

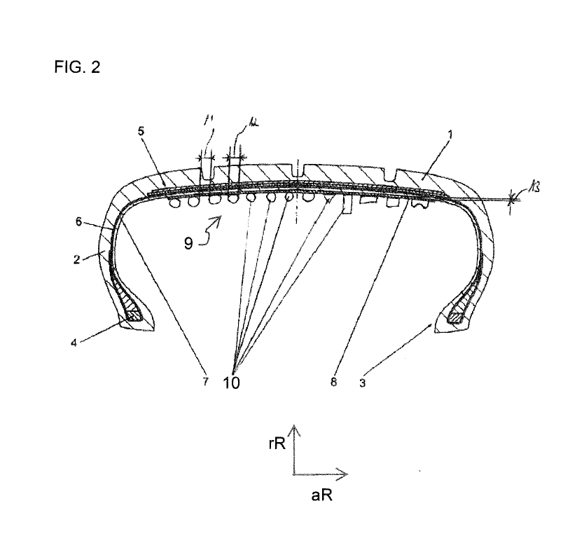

FIG. 2 shows a cross section through a pneumatic vehicle tire according to the invention. The pneumatic vehicle tire of FIG. 2 differs from the pneumatic vehicle tire of FIG. 1 in that the sound absorber 9 is made up of a plurality of annular component sound-absorber elements 10 that extend in the circumferential direction. Here, two directly adjacently arranged annular component sound-absorber elements 10 are arranged at a distance 11 from one another in the axial direction aR.

In FIG. 2, the left half of the cross section shows component sound-absorber elements 10, which in cross section have the form of a circle, by way of example for the entire cross section of the tire. When viewed over the circumference of the tire, the annular component sound-absorber elements 10 adhere linearly to the sealant 8, so that there is a great free sealant surface. Each of the component sound-absorber elements 10 is of approximately the same size and has a width 12 of 8 mm to 12 mm, preferably of 10 mm, measured in the axial direction aR at the level of the widest extent of the component sound-absorber elements 10. The axial distance 11 of the component sound-absorber elements 10 between two directly adjacently arranged component sound-absorber elements 10 is 8 mm to 12 mm, preferably approximately 10 mm, measured in the axial direction aR at the elevation of the widest extent of the component sound-absorber elements 10. The layer thickness 13 of the sealant 8 is very small and is approximately 3.5 mm.

On the right half of the drawing, various possible cross-sectional geometries of component sound-absorber elements 10, such as semicircles and a wide variety of polygons, such as a triangle, rectangle—horizontal or upright—or a square, are shown by way of example, the sound absorber 9 is preferably made up, however, of component sound-absorber elements 10 of the same geometry.

It is understood that the foregoing description is that of the preferred embodiments of the invention and that various changes and modifications may be made thereto without departing from the spirit and scope of the invention as defined in the appended claims.

### LIST OF REFERENCE SIGNS

1 Tread
2 Sidewall
3 Bead region
4 Bead core
5 Belt assembly
6 Carcass insert
7 Inner layer
8 Sealant layer
9 Inner absorber/sound absorber
10 Component sound-absorber element
11 Distance
12 Width of a component sound-absorber element
13 Layer thickness of the sealant
aR Axial direction
rR Radial direction

What is claimed is:

1. A pneumatic vehicle tire defining a tire circumference and comprising:
a tire body defining an axial direction and having a tread and inner surface lying opposite said tread;
said inner surface defining the interior of said vehicle tire;
a sound absorber of foam material running in said interior and applied adheringly in an annular manner to said inner surface over said tire circumference;
a self sealing sealant applied in advance to which said sound absorber adheres;
said sealant having a tackiness at least directly after application thereof required for causing said sound absorber to adhere;
said sound absorber including a plurality of annular-shaped component sound absorbing elements running in the direction of said tire circumference;
said component sound absorbing elements being arranged one next to the other in said axial direction; and,
two mutually adjacent ones of said component sound absorbing elements conjointly defining a clear distance therebetween in said axial direction.

2. The pneumatic vehicle tire of claim 1, wherein said clear distance lies in a range of 5 mm to 200 mm measured in said axial direction at an elevation corresponding to the broadest extent of the corresponding component sound absorbing elements.

3. The pneumatic vehicle tire of claim 1, wherein said clear distance lies in a range of 5 mm to 100 mm measured in said axial direction at an elevation corresponding to the broadest extent of the corresponding component sound absorbing elements.

4. The pneumatic vehicle tire of claim 1, wherein said clear distance lies in a range of 10 mm to 20 mm measured in said axial direction at an elevation corresponding to the broadest extent of the corresponding component sound absorbing elements.

5. The pneumatic vehicle tire of claim 1, wherein said component sound absorbing elements have a cross section having a form corresponding to at least one of the following: a circle, a half circle, an irregular polygon, a regular polygon including a regular triangle or a regular quadrilateral.

6. The pneumatic vehicle tire of claim 1, wherein each one of said component sound absorbing elements has a width lying in a range of 5 mm to 15 mm measured in said axial direction at an elevation of widest extent of said one of said component sound absorbing elements.

7. The pneumatic vehicle tire of claim 1, wherein each one of said component sound absorbing elements has a width lying in a range of 8 mm to 12 mm measured in said axial direction at an elevation of widest extent of said one of said component sound absorbing elements.

8. The pneumatic vehicle tire of claim 1, wherein each one of said component sound absorbing elements has a width lying in a range of 8 mm to approximately 10 mm measured in said axial direction at an elevation of widest extent of said one of said component sound absorbing elements.

9. The pneumatic vehicle tire of claim 1, wherein said sealant is a polyurethane gel.

10. The pneumatic vehicle tire of claim 1, wherein said sealant is a viscous mixture on the basis of one of the following: a butyl rubber, polybutene or silicone.

11. The pneumatic vehicle tire of claim 1, wherein said sealant has a thickness lying in a range of 2 mm to 5 mm.

12. The pneumatic vehicle tire of claim 1, wherein said sealant has a thickness lying in a range of 2 mm to approximately 3.5 mm.
